(19) United States
(12) Patent Application Publication
(10) Pub. No.: US 2008/0040152 A1
(43) Pub. Date: Feb. 14, 2008

(54) Systems and Methods for Health Management of Single or Multi-Platform Systems

(75) Inventors: John L. Vian, Renton, WA (US); Gregory J. Clark, Seattle, WA (US)

Correspondence Address: LEE & HAYES, PLLC, 421 W. RIVERSIDE AVE., SUITE 500, SPOKANE, WA, 99201, US

(73) Assignee: THE BOEING COMPANY, Chicago, IL (US)

(21) Appl. No.: 11/745,258

(22) Filed: May 7, 2007

Related U.S. Application Data
(60) Provisional application No. 60/822,049, filed on Aug. 10, 2006.

(51) Int. Cl. G06Q 50/00

(52) U.S. Cl. 705/2

(57) ABSTRACT

Systems and methods for health data management are disclosed. In one embodiment, a method of monitoring health information for a multi-platform system includes receiving health information from one or more subsystems of a plurality of platforms, and analyzing the health information using one or more reasoner algorithms configured to predict a potential failure of the one or more subsystems. Upon prediction of a potential failure, the method includes providing a prognostic characteristic of the one or more subsystems. In alternate embodiments, the method may further include translating at least some of the health information for each of the one or more subsystems into a common format, and storing the translated health information into a database for subsequent analysis.

### CROSS REFERENCE TO RELATED APPLICATIONS

This patent application claims priority under 35 U.S.C. §120 from U.S. Provisional Application No. 60/822,049 filed Aug. 10, 2006, which provisional application is incorporated herein by reference.

### FIELD OF THE INVENTION

Embodiments of the invention relate generally to systems and methods for health data management, including health management systems and methods for health data handling and prognostic reasoning for multiple types of systems.

### BACKGROUND OF THE INVENTION

Modern health management of complex machines and systems, including complex aerospace systems, may go beyond simply monitoring operating conditions. Health management may also include assimilation of available information for determination of predicted failure modes and failure times, possible corrective actions, and planning and scheduling options. Thus, health management may provide a number of interconnected and cooperative functions to comprehensively manage the health of the system.

Although prior art systems and methods have achieved desirable results, there is room for improvement. For example, conventional health management systems for aircraft are typically highly-individualized, employing customized frameworks, individualized prognostic algorithms, and dissimilar data management and storage techniques. The current lack of commonality among various health management systems inhibits the ability to merge various types of onboard and offboard generated data across the particular aircraft, or across groupings of aircraft (e.g. squadron or fleet of aircraft assigned to a particular flight route). Novel systems and methods that mitigate these negative characteristics of the prior art would therefore have utility.

### SUMMARY OF THE INVENTION

Embodiments of systems and methods in accordance with the present disclosure are directed to health data management, including health data management for multi-platform systems. Such embodiments may advantageously increase aircraft system reliability, safety, maintainability, availability, and affordability resulting in improved mission performance and operational capabilities.

In one embodiment, a method of monitoring health information for a multi-platform system includes receiving health information from one or more subsystems of a plurality of platforms, and analyzing the health information using one or more reasoner algorithms configured to predict a potential failure of the one or more subsystems. Upon prediction of a potential failure, the method includes providing a prognostic characteristic of the one or more subsystems. In alternate embodiments, the method may further include translating at least some of the health information for each of the one or more subsystems into a common format, and storing the translated health information into a database for subsequent analysis.

In further embodiments, the plurality of platforms may include one or more flight vehicles, and analyzing the health information may include retrieving the translated health information from the database, and analyzing the translated health information using one or more ground-based reasoner algorithms. Alternately, providing a prognostic characteristic may include providing a repair order, a replacement order, and a maintenance order.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

Embodiments of systems and methods in accordance with the present disclosure are described in detail below with reference to the following drawings.

FIG. 1 is a schematic view of a method of performing integrated health management of a multi-platform system in accordance with an embodiment of the invention;

FIG. 2 is a schematic view of a system for performing multi-platform integrated health management in accordance with an embodiment of the invention;

FIG. 3 shows a representative plurality of health data sources for a military aircraft and a commercial aircraft;

FIG. 4 is a representative test data collection process for a military aircraft being tested at a test station;

FIG. 5 is a representative health data collection process for a commercial aircraft;

FIG. 6 is another representative health data collection process for a military aircraft;

FIG. 7 is another representative health data collection process for another aircraft;

FIG. 8 is still another representative health data collection process for an aircraft; and

FIG. 9 shows representative diagnostic reasoning algorithms suitable for use in systems and methods in accordance with alternate embodiments of the invention.

### DETAILED DESCRIPTION

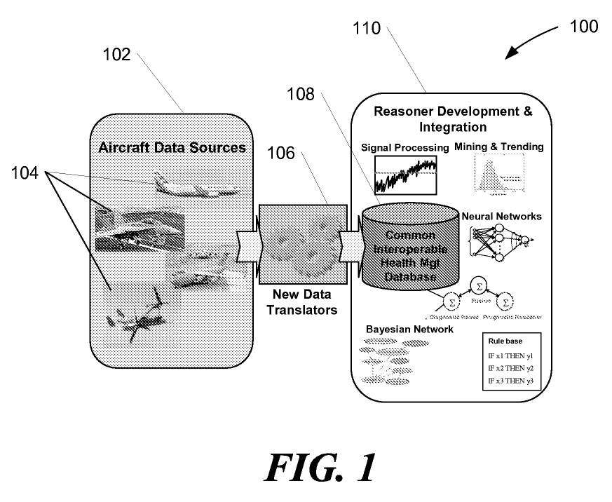

The present disclosure relates to systems and methods for health data management, including health data management for multi-platform systems. Many specific details of certain embodiments are set forth in the following description and in FIGS. 1-9 to provide a thorough understanding of such embodiments. One skilled in the art, however, will understand that the present invention may have additional embodiments, or that the present invention may be practiced without several of the details described in the following description.

In general, embodiments of systems and methods in accordance with the present disclosure may provide capabilities to translate, store in a common format, view, analyze, merge, and process (via model-based and non-model-based diagnostic and prognostic algorithms) data from multiple aircraft health management data sources. Such systems and methods may enable common algorithms to be re-used for operation on data from multiple aircraft types, and from multiple aircraft health management data sources, including: 1) operational data (e.g. parameter data and faults), 2) maintenance data (e.g. maintenance actions, part installations and removals, and test stand data), and 3) reference data (e.g. flight recorder configuration, software configuration, fault tolerance levels, expected parameters, test stand configuration data, system and subsystem organization, and engineering units).

FIG. 1 is a schematic view of a method 100 of performing integrated health management of a multi-platform system in accordance with an embodiment of the invention. The method 100 includes receiving health information at a block 102 from one or more subsystems of a plurality of platforms 104. In the embodiment shown in FIG. 1, the platforms 104 are depicted as various types of commercial and military aircraft, however, it will be appreciated that in alternate embodiments, other suitable types of platforms may be monitored. In the event that the health information received from the plurality of platforms is not in a common format, then the health information may be appropriately translated into a common format at a block 106, and may be stored within a common interoperable health management database at a block 108.

As further shown in FIG. 1, at a block 110, the health information is analyzed using one or more reasoner algorithms. In some embodiments, the one or more reasoner algorithms are configured to diagnose and/or predict a potential failure of the one or more subsystems, including, for example, failure mode, time of failure, etc. Upon diagnosis or prediction of a potential failure, the analysis performed at block 110 may further provide a diagnostic or prognostic characteristic of the one or more subsystems, such as a repair order, a replacement order, a maintenance order, or any other suitable prognostic characteristics. The analysis performed at block 110 may also include mining and trending analyses, or any other desired analyses.

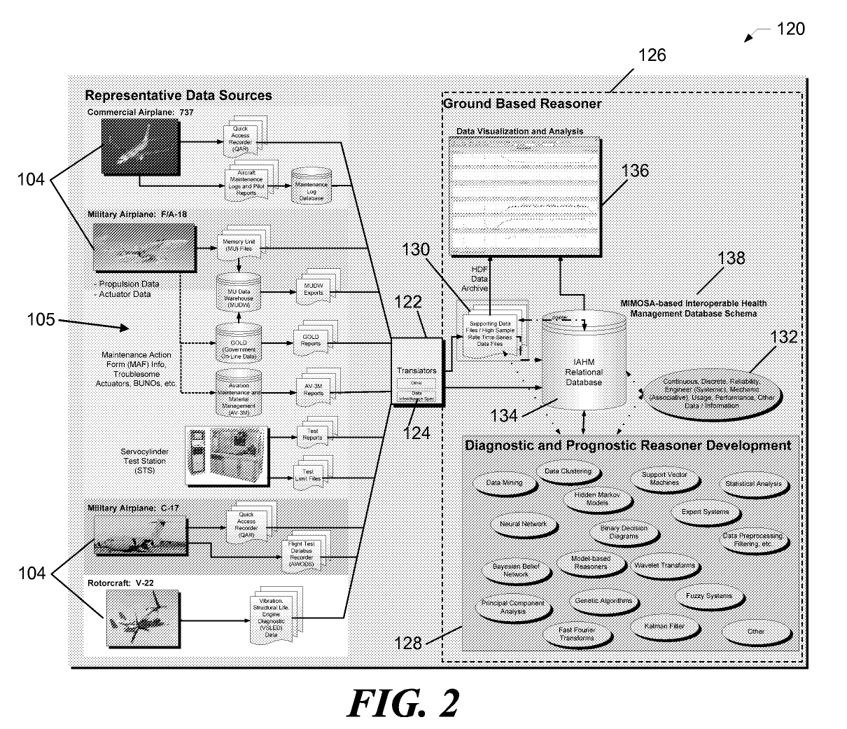

FIG. 2 is a schematic view of a system 120 for performing multi-platform integrated health management in accordance with an embodiment of the invention. As noted above, the system 120 includes one or more translators 122 that convert health information received from the plurality of platforms 104 into a common format. As noted above, the platforms 104 may be flight vehicles or any other suitable types of platforms. Alternately, the health information may be provided by maintenance personnel, maintenance systems, and component or subsystem tests 105, such as may be conducted on test stands, laboratories, wind tunnels, or any other suitable test environment. The one or more translators 122 may operate in accordance with a data interchange specification 124 to properly convert the health information into the desired common format.

The system 120 further includes a reasoner module 126. The reasoner module 126 analyzes the health information using one or more reasoner algorithms 128. As noted above, the one or more reasoner algorithms 128 may be configured to diagnose failures, to provide prognostics, to perform data mining and trending analyses, or any other desired types of analyses. The reasoner module 126 may operate on one or more data files 130 that may be accessed by the reasoner algorithms 128 to perform the desired analyses. The one or more data files 130 may be used to store large volumes of high-sample rate (e.g. 100 Hz for several flight hours) data that are seldomly used by the reasoner module 126, e.g. for specific event-driven analyses. The data files may be compressed for efficient long-term storage and optimized for fast retrieval of historical data. For example, using Hierarchical Data Format, Version 5 (HDF5), a general-purpose, machine-independent standard for storing scientific data developed by the National Center for Supercomputing Applications (NCSA). The data files 130 may be linked (via software pointers) to the relational database 134 for use by the reasoner algorithms 128.

As further shown in FIG. 2, the reasoner module 126 of the health management system 120 may include a relational database 134. The relational database 134 may be used for storing many types of vehicle health management data (provided by translators 122). It may also include access to high rate data files 130 stored externally to the relational database for infrequent event-driven detailed analyses of specific data parameters. In further embodiments, the relational database 134 may advantageously enable one or more of the following three basic vehicle health management data associations: 1) multiple data set associated from the same data source (e.g. aircraft flight data compared from one flight to the next), 2) two different data sources from the same aircraft (e.g. aircraft flight data compared to maintenance action data compared to test stand data for a particular part), and 3) multiple different aircraft platforms (e.g. airplane to rotorcraft). The reasoner 126 may also include a support database 132. The support database may include empirical or analytically derived information regarding failure modes of one or more subsystems of the various platforms 104, system design specifications, and maintenance information, and operator knowledge. The reasoner module 126 may also include a data visualization component 136 that enables visual (e.g. graphical) analysis of the health information, the relational information from the relational database 134, as well as the results of the analyses performed by the reasoner algorithms 128.

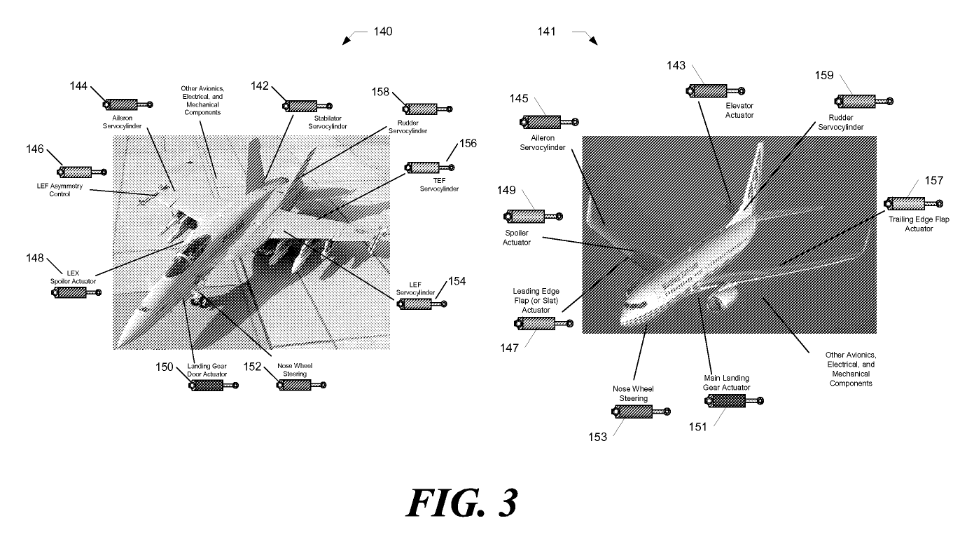

Embodiments of methods and systems in accordance with the present invention may be used for monitoring and managing multi-platform systems having a wide variety of health information sources. For example, FIG. 3 shows a plurality of health data sources for a representative military aircraft 140 and a representative commercial aircraft 141. For the military aircraft 140, the plurality of health data sources includes one or more components of a stabilator assembly 142 which provides position control of horizontal tail surfaces, one or more components of an aileron assembly 144 for controlling aileron position, one or more components of an LEF (Leading Edge Flap) assembly 146 for controlling symmetry characteristics, one or more components of an LEX (Leading Edge Extension) assembly 148 for actuating aircraft spoilers, one or more components of a nose landing gear assembly 150, one or more components of a nose wheel steering assembly 152, one or more components of an LEF HDU (Hydraulic Drive Unit) assembly 154, one or more components of a TEF (Trailing Edge Flap) assembly 156, and one or more components of a rudder control assembly 158. Of course, any other desired sources of health data may be used, including avionics systems, engines and other propulsion system components, and any other desired systems and subsystems.

Similarly, for the commercial aircraft 141, the plurality of health data sources includes an elevator actuator 143 for elevator control, an aileron assembly 145 for controlling aileron position, one or more components of an LEF or LES (Leading Edge Slat) assembly 147, a spoiler actuator 149 for actuating aircraft spoilers, one or more components of a landing gear assembly 151, one or more components of a nose wheel steering assembly 153, one or more components of a TEF assembly 157, and one or more components of a rudder control assembly 159. Other avionics, electrical, and mechanical components of the aircraft 141 may also be monitored.

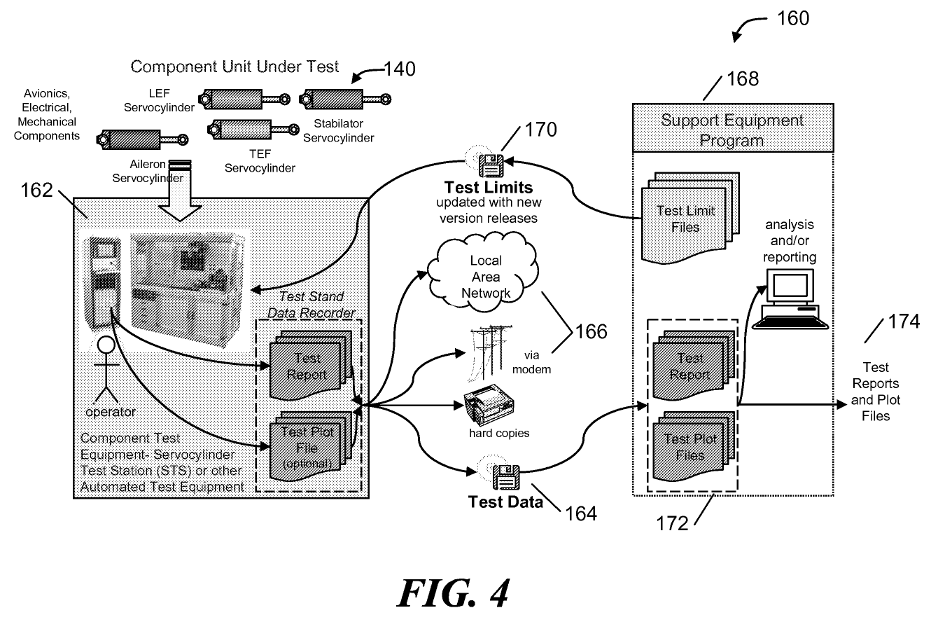

It will be appreciated that embodiments of systems and methods in accordance with the present disclosure may use health information obtained from tests conducted on the systems and subsystems of the various platform types. For example, FIG. 4 is a representative test data collection process 160 for a military aircraft 140 being tested at a test station 162. In the embodiment shown in FIG. 4, the test station 162 is depicted as a servocylinder test station (STS), which is a hydraulic test station used to perform fully automated performance verification and diagnostic fault isolation on flight control servoactuators and servoactuator subassemblies removed from the military aircraft 140 at intermediate and depot levels. Such test stations are available for various types of aircraft and aircraft components.

The data collection process 160 shown in FIG. 4 provides digital data on the results of the tests performed on all health information sources of the aircraft 140, including the flight control actuators described above with respect to FIG. 3. A control component 168 may provide a test plan or a prescribed set of test limits 170 to the test station 162 to ensure that the desired health information is acquired during the testing. Test data 164 acquired using the test station 162 may include a summary of the test results, as well as the actual raw data stream captured during the test. These data 164 may be stored on a storage device, or transmitted via a communication network 166 (e.g. local area network, global network, modem, wireless link, etc.) for subsequent post-processing and analysis.

The test data 164 are communicated to an analysis module 172, which in this embodiment is shown as part of the control component 168. The analysis module 172 may perform a method of managing health information in accordance with the teachings of the present disclosure, such as the methods described above with respect to FIGS. 1 and 2. Alternately, the analysis module 172 may perform selected portions of the methods described above, such as translating the test data 164 into a desired format for transmittal and subsequent analysis by the one or more reasoner algorithms. In further embodiments, output data 174 from the control component 168 may remain unprocessed and may be input to a separate system, such as the system 120 described above and shown in FIG. 2, for processing and analysis.

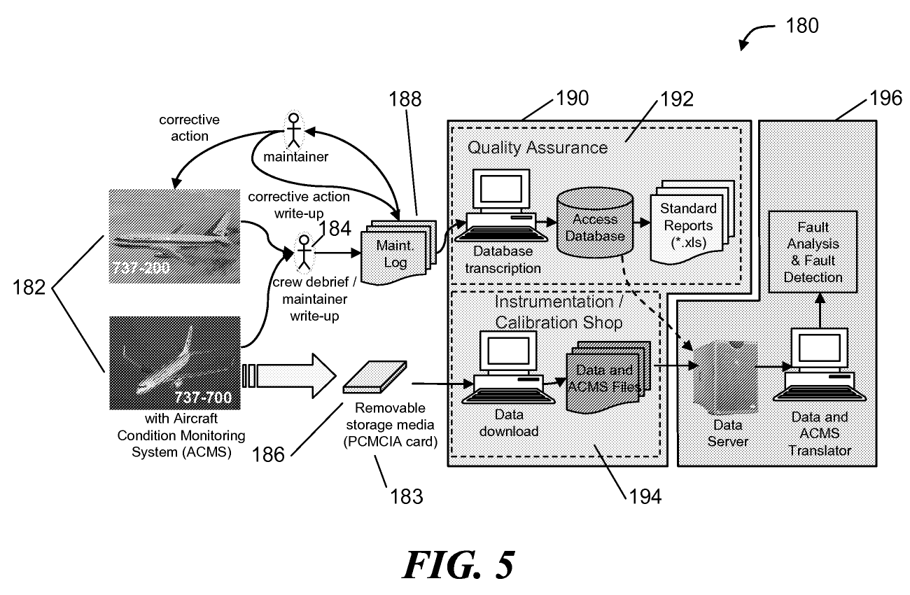

FIG. 5 is a representative health data collection process 180 for gathering health information from one or more commercial aircraft 182. In this embodiment, the process 180 includes one or more personnel of an airplane operator (e.g. commercial airline company) to support development of the health data 183. More specifically, the health data 183 may include write-ups or reports 184 by airline crew or maintenance personnel, which may be assembled as aircraft maintenance logs 188, as well as cartridge retrieval data 186 from operational aircraft. In some embodiments, data sources and health data for commercial airplanes 182 may include Aircraft Condition Monitoring System (ACMS) reports, Aircraft Maintenance Logs, and Quick Access Recorder (QAR) data. Alternately, health data may be obtained for commercial aircraft from laboratory data collection, and other means appropriate to access health management data that provide a sample of cross-platform data exhibiting a diversity of types (e.g. fault codes, processed continuous, discrete, sampled high-bandwidth, context, etc.) and preferably conducive to use by advanced diagnostic reasoners.

As further shown in FIG. 5, the health data 183 may be input to a data gathering component 190, which may include a quality assurance portion 192 and an instrumentation and calibration portion 194. The health data 183 are then transmitted to a health data management component 196 which includes systems and performs methods in accordance with the present disclosure, such as the systems and methods described more fully above.

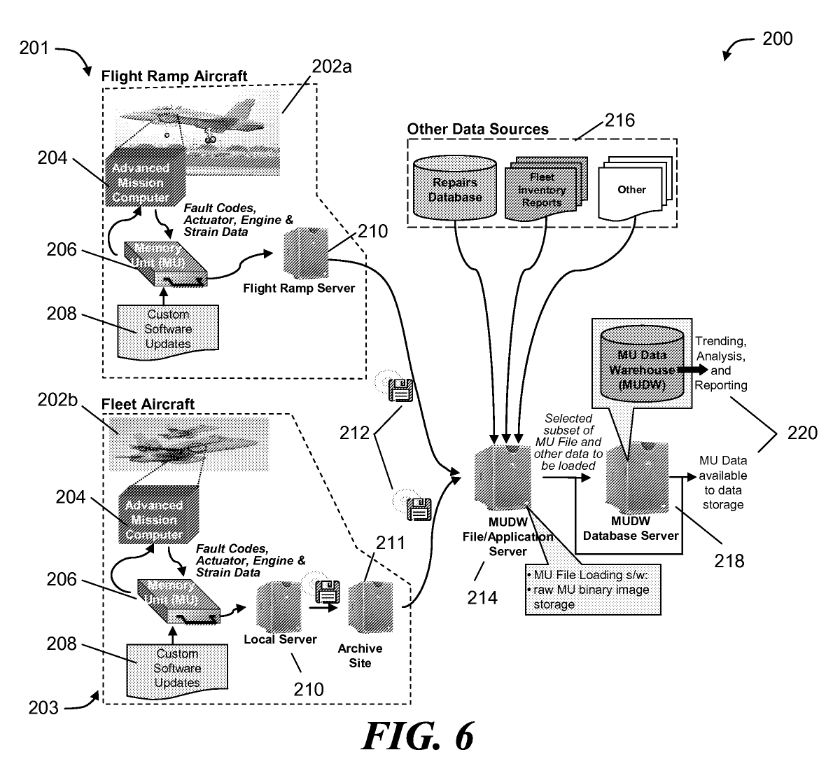

FIG. 6 is another representative health data collection process 200. In this embodiment, the process 200 includes a first branch 201 that collects data from newly-built, pre-delivery aircraft 202a, and a second branch 203 that collects data from in-service aircraft 202b. The first and second branches 201, 203 have several components in common, and therefore, for the sake of brevity, the following description applies to both the first and second branches 201, 203 unless otherwise stated. As shown in FIG. 6, the military aircraft 202a, 202b include a mission computer 204 operatively coupled to a memory unit 206. A supplementary software program 208 is loaded to the memory unit 206 (and to the mission computer 204 during powerup). The supplementary software program 208 is configured to perform functions, such as suppressing known nuisance information, between updates to the mission computer 204.

Health data from the memory unit 206 are transmitted to a server 210, and in the second branch 203, to an archive 211 for storage. The health data are then transmitted (e.g. as data files 212) to a warehouse server 214 that also receives health data from other data sources 216. As depicted in FIG. 10, access to all the data downloaded from the memory units may be provided, or alternately, if it is not practical to host all the data on a server due to the sheer volume of data that is contained on each memory unit, a selective subset of this data may be identified and retrieved. The selected sets or subsets of health data may be provided to a second warehouse server 218, and final health data 220 may be output from the second warehouse server 218 in a variety of formats using a variety of storage media for subsequent analysis using methods and systems as described above.

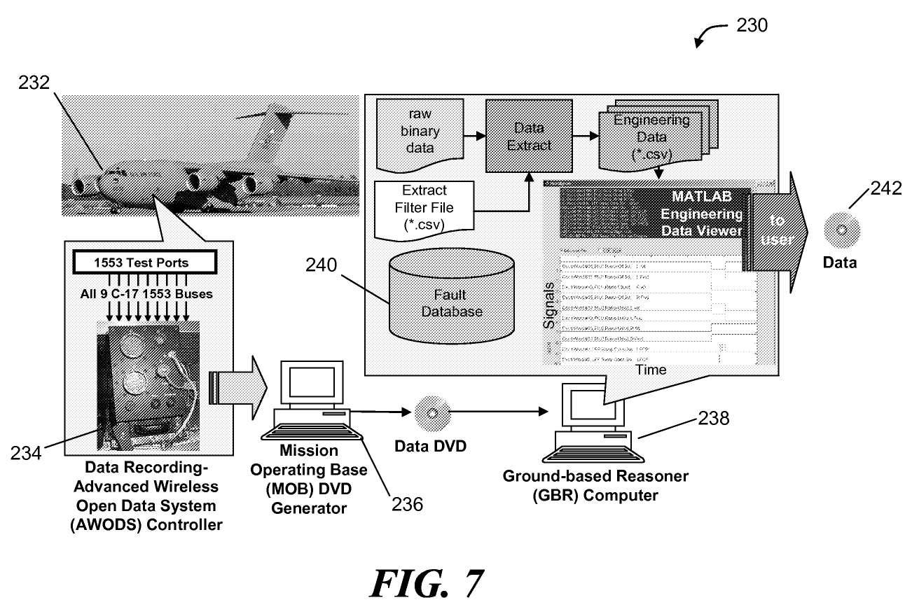

FIG. 7 is another representative health data collection process 230 for another aircraft 232. In this embodiment, the aircraft 232 includes an on-board controller 234 that includes a data recorder. In a particular embodiment, the on-board controller 234 is an Advanced Wireless Open Data System (AWODS) installed in an avionics rack of the aircraft 232. The data recorder media or the on-board controller 234 is removed from the aircraft 232 and coupled to a server 236 which downloads the desired health data. One or more portions of the method 100 described above may be performed on the server 236 (e.g. translating and formatting the health data into a common format), or alternately, the health data may be transmitted to a fleet management server 238, which may perform one or more remaining portions of the method (or portions thereof) in accordance with the present disclosure. A fault database 240 is included in the fleet management server 238. The health data 242 from the on-board controller 234 may be stored in the fault database 240, and may be communicated to a health management system (e.g. system 120 described above) for further analysis.

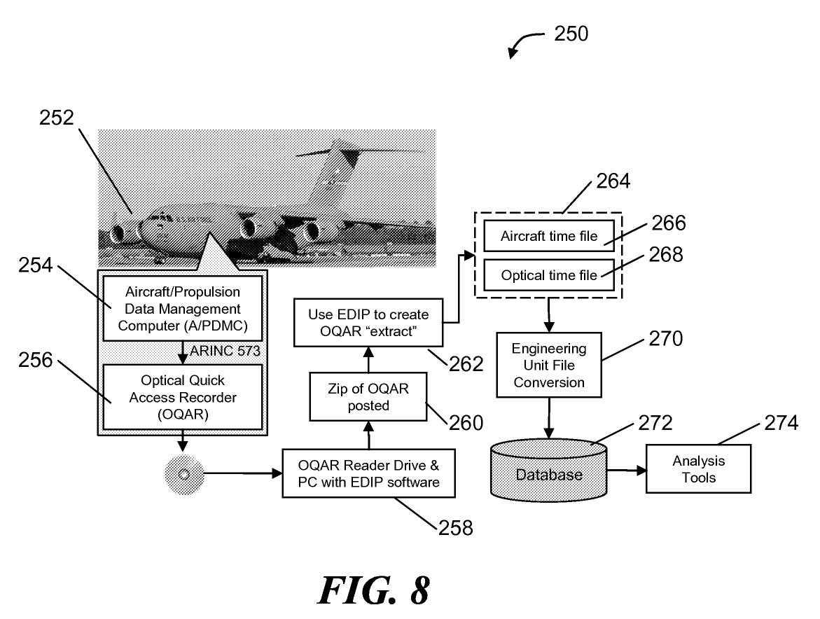

FIG. 8 is still another representative health data collection process 250 for an aircraft 252 that includes a data management computer 254, and a recorder 256 coupled to the data management computer 254. In a particular embodiment, the recorder 256 may be an Optical Quick Access Recorder (OQAR). A server 258 receives health data from the recorder 256 and may output these data in a first format 260 (e.g. a Zip file). At an interim block 262, the health data may be modified, such as by extracting a portion of the data from the recorder 256 for further analysis. The resulting data are then received at an interface module 264, which may include an aircraft (A/C) time file 266, an optical time file 268, or other assorted files. The data from the interface module 264 may undergo a conversion at a block 270, such as an engineering units conversion, prior to entry into a database 272. The health data may then be selectively accessed using analysis tools 274 for subsequent analysis and management.

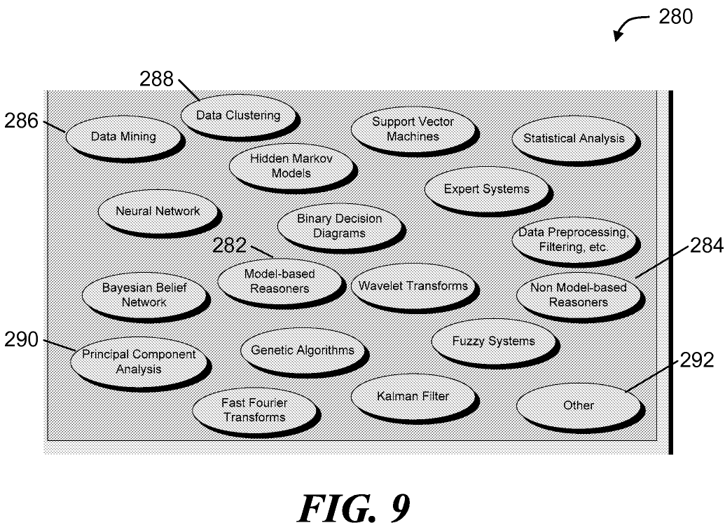

FIG. 9 shows a plurality of representative diagnostic reasoning algorithms 280 suitable for use in systems and methods in accordance with alternate embodiments of the invention. The reasoning algorithms 280 include model based techniques 282 and non-model based techniques 284. More specifically, the reasoning algorithms 280 may include one or more data mining algorithms 286, data clustering 288 (e.g. data clustering using Trellis Diagram and Fisher Class Separability Measures), principal or independent component analysis (PCA or ICA) algorithms 290, and any other suitable pre-processing or reasoning algorithms 292 such as clustered Self-Organizing Maps (SOM) algorithms, wavelet pre-processing of optimal data features algorithms, model-based fault detection and identification (ID) algorithms, interacting multi-model estimator algorithms, and hybrid probabilistic neural network (NN) classifiers.

From the foregoing description, it may be appreciated that embodiments of systems and methods in accordance with the present disclosure may advantageously provide an architectural framework, including data translation, storage, and diagnostic/prognostic analysis tools, to perform aircraft health assessments. Long-term benefits of such systems and methods may include: 1) development of technologies that address total ownership cost reduction, expeditionary logistics, and warfighter protection and enhanced safety, 2) reduced operating costs through life-extension of legacy systems and improved diagnostic tools to decrease the number of unnecessary parts removals, 3) improved affordability and safety throughout the commercial air transportation industry—specifically, airline gate delay and air turnback/diversion costs will be reduced due to improved system health monitoring and prognostics, 4) additional cost reductions and safety improvement will result from new condition-based maintenance practices, 5) enable cost effective monitoring and assessment of existing aircraft data, 6) increase availability of warfighter assets resulting in reduced overall acquisition cost, 7) increase unmanned air vehicle (UAV) mission completion and increase survivability through Integrated Systems Health Management (ISHM) with reconfigurable control, and 8) more fully utilize the available data to achieve economic and safety objectives.

Various modules and techniques may be described herein in the general context of computer-executable instructions, such as program modules, executed by one or more computers or other devices. Generally, program modules include routines, programs, objects, components, data structures, and so forth for performing particular tasks. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on or transmitted across some form of computer readable media.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method of monitoring health information for a multi-platform system, comprising:
receiving health information from one or more subsystems of a plurality of platforms;
analyzing the health information using one or more reasoner algorithms configured to at least one of diagnose and predict a potential failure of the one or more subsystems;
upon diagnosis of a failure, providing recommended action; and
upon prediction of a potential failure, providing a prognostic characteristic of the one or more subsystems.

2. The method of claim 1, further comprising:
translating at least some of the health information for each of the one or more subsystems into a common format; and
storing the translated health information into a database for subsequent analysis.

3. The method of claim 2, wherein the plurality of platforms include one or more flight vehicles, and wherein analyzing the health information includes:
retrieving the translated health information from the database; and
analyzing the translated health information using one or more ground-based reasoner algorithms.

4. The method of claim 1, wherein providing a prognostic characteristic includes providing at least one of a repair order, a replacement order, and a maintenance order.

5. The method of claim 1, wherein analyzing the health information includes analyzing the health information using a relational database.

6. The method of claim 5, wherein analyzing the health information using a relational database includes analyzing the health information using a relational database that enables at least one of the following data associations: 1) multiple data set associated from the same data source, 2) two different data sources from the same aircraft, and 3) multiple different aircraft platforms.

7. A system for monitoring health information for a multi-platform system, comprising:
a first component configured to receive health information from one or more subsystems of a plurality of platforms;
a second component configured to analyze the health information using one or more reasoner algorithms configured to at least one of diagnose and predict a potential failure of the one or more subsystems; and
a third component configured to, upon diagnosis of a failure, provide recommended action, and upon prediction of a potential failure, provide a prognostic characteristic of the one or more subsystems.

8. The system of claim 7, further comprising:
a fourth component configured to translate at least some of the health information for each of the one or more subsystems into a common format; and
a fifth component configured to store the translated health information into a database for subsequent analysis.

9. The system of claim 8, wherein the plurality of platforms include one or more flight vehicles, and wherein the second component is further configured to:
retrieve the translated health information from the database; and
analyze the translated health information using one or more ground-based reasoner algorithms.

10. The system of claim 7, wherein the third component is further configured to provide at least one of a repair order, a replacement order, and a maintenance order.

11. The system of claim 7, wherein the second component is further configured to analyze the health information using a relational database.

12. The system of claim 7, wherein the second component is further configured to analyze the health information using a relational database that enables at least one of the following data associations: 1) multiple data set associated from the same data source, 2) two different data sources from the same aircraft, and 3) multiple different aircraft platforms.

13. One or more computer-readable media containing computer-readable instructions that, when executed, perform a method of monitoring health information for a multi-platform system, comprising:
receiving health information from one or more subsystems of a plurality of platforms;
analyzing the health information using one or more reasoner algorithms configured to at least one of diagnose and predict a potential failure of the one or more subsystems;
upon diagnosis of a failure, providing recommended action; and
upon prediction of a potential failure, providing a prognostic characteristic of the one or more subsystems.

14. The computer-readable media of claim 13, wherein the method further comprises:
translating at least some of the health information for each of the one or more subsystems into a common format; and
storing the translated health information into a database for subsequent analysis.

15. The computer-readable media of claim 14, wherein the plurality of platforms include one or more flight vehicles, and wherein analyzing the health information includes:
retrieving the translated health information from the database; and
analyzing the translated health information using one or more ground-based reasoner algorithms.

16. The computer-readable media of claim 13, wherein providing a prognostic characteristic includes providing at least one of a repair order, a replacement order, and a maintenance order.

17. The computer-readable media of claim 13, wherein analyzing the health information includes analyzing the health information using a relational database.

18. The computer-readable media of claim 13, wherein analyzing the health information using a relational database includes analyzing the health information using a relational database that enables at least one of the following data associations: 1) multiple data set associated from the same data source, 2) two different data sources from the same aircraft, and 3) multiple different aircraft platforms.
